(19) United States
(12) Patent Application Publication
(10) Pub. No.: US 2026/0039163 A1
(43) Pub. Date: Feb. 5, 2026

(54) INDUCTION MACHINE HAVING OPTIMIZED ROTOR AND DIRECT COOLING

(71) Applicant: FCA US LLC, Auburn Hills, MI (US)

(72) Inventors: Reemon Haddad, Auburn Hills, MI (US); Dhafar Al-Ani, Auburn Hills, MI (US)

(21) Appl. No.: 18/788,390

(22) Filed: Jul. 30, 2024

(51) Int. Cl. H02K 1/32; B60K 1/00; H02K 17/16

(52) U.S. Cl. CPC H02K 1/32; H02K 17/168; B60K 1/00

(57) ABSTRACT

An electric machine for powering an electric vehicle includes a rotor assembly configured to rotate relative to a stator to drive a rotor shaft of the electric vehicle. The rotor assembly includes a rotor core and a bar assembly. The rotor core has a core body that includes a plurality of first laminations that define a plurality of circumferentially arranged bar passages and a plurality of coolant channels comprising a coolant channel arranged between adjacent bar passages. The bar assembly includes a plurality of bars received at the bar passages in the rotor core, each of the bars having an inboard body portion, an outboard body portion, and inwardly extending concave portions defined on opposite sides of the bars. A coolant channel of the plurality of coolant channels is arranged intermediate adjacent bars of the plurality of bars and aligned generally between respective opposing inwardly extending concave portions.

### FIELD

The present application relates generally to induction machines and, more particularly, to a rotor assembly for a squirrel-cage induction machine having an improved cooling configuration.

### BACKGROUND

Different types of electric vehicles, including mild hybrid electric vehicles (mHEV's), plug-in hybrid electric vehicles (PHEV's), battery electric vehicles (BEV's), and range extended battery electric vehicles (REEV's), rely on electric machines for propulsion as a main source of torque, which generates the necessary power for vehicle propulsion. One type of electric machine is an induction machine (IM) or an asynchronous machine that operates based on the principles of electromagnetic induction. IM's generally come in two configurations, a squirrel-cage rotor and a wound rotor. A squirrel-cage rotor includes bars or rods made of electrically conducting materials, typically aluminum or copper, or any other alloy that are positioned radially in the rotor core. These bars are arranged in a parallel relationship to the IM shaft and are evenly spaced radially around the circumference of the rotor. The conductive bars are connected at each end by short-circuiting rings, creating a closed-loop circuit. Heat management is a crucial consideration in the design and operation of IM's, especially regarding the rotor. Excessive heat in the rotor bars or rods can lead to various performance issues. In this regard, while existing squirrel-cage rotor configurations can be satisfactory, there remains a need for improvement in the relevant art.

### SUMMARY

In accordance with one example aspect of the invention, an electric machine for powering an electric vehicle includes a rotor assembly configured to rotate relative to a stator to drive a rotor shaft and at least one drive wheel of the electric vehicle. The rotor assembly includes a rotor core and a bar assembly. The rotor core has a core body that includes a plurality of first laminations that define a plurality of circumferentially arranged bar passages and a plurality of coolant channels comprising a coolant channel arranged between adjacent bar passages. The bar assembly includes a plurality of bars received at the bar passages in the rotor core, each of the bars having an inboard body portion, an outboard body portion, and inwardly extending concave portions defined on opposite sides of the bars. A coolant channel of the plurality of coolant channels is arranged intermediate adjacent bars of the plurality of bars and aligned generally between respective opposing inwardly extending concave portions.

In examples, the core body includes a rotor core separating portion having an area that is at least a corresponding area of the coolant channel.

In examples, the bars further include outwardly extending finger portions on opposed ends of the respective concave portions.

In other examples, the rotor core further comprises a first end lamination positioned at a first end of the rotor core and a second end lamination positioned at a second end of the rotor core.

In other implementations, the first and second end laminations include a plurality of cooling flow guides formed therein, the plurality of cooling flow guides fluidly connected to the coolant channels.

In examples, the first and second end laminations control flow of coolant into and out of the rotor core.

In other examples, the coolant channels are oval shaped.

In additional implementations, an area of an inwardly extending concave portion is equal to a sum of an area of outwardly extending finger portions on opposed ends of the inwardly extending concave portion.

In other examples, a stator assembly includes a stator core having stator windings thereon.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric vehicle drivetrain having an electric drive module that incorporates a squirrel-cage induction motor assembly, in accordance with the principles of the present application;

FIG. 2 is a sectional view of the squirrel-cage induction motor assembly shown in FIG. 1, in accordance with the principles of the present application;

FIG. 3A is sectional view of the rotor core and associated bars or rods of the squirrel-cage induction rotor assembly of FIG. 2, in accordance with one example of the present application;

FIG. 3B is a detail view of the rotor core and associated bars or rods of the squirrel-cage induction rotor at area 3B of FIG. 3A;

FIG. 4 is a plan view of an exemplary first bar or rod shown in FIGS. 2-3B according to examples of the present disclosure;

FIGS. 5A-5L are sectional view of various exemplary alternative coolant channels according to additional examples of the present disclosure;

FIG. 6 is a sectional view of a rotor core and associated bars or rods of the squirrel-cage induction rotor assembly and incorporating cooling flow guides in accordance with a second example of the present application, the rotor core and associated bars or rods configured for use at opposite ends of the rotor core; and

FIG. 7 is a sectional view of a rotor lamination showing coolant flow according to various examples of the present disclosure.

### DETAILED DESCRIPTION

As noted above, a squirrel-cage IM rotor includes bars or rods (hereinafter “bars”) made of electrically conducting materials, such as aluminum or copper, or any other alloy, that are positioned radially in the rotor core. These bars are arranged in a parallel relationship to the IM shaft and are evenly spaced radially around the circumference of the rotor. The conductive bars are connected at each end by short-circuiting rings, creating a closed-loop circuit. Heat management is critical to the operation of IM's, especially at the rotor.

According to the principles of the present application, a squirrel-cage IM rotor is disclosed that improves the thermal performance of the squirrel-cage IM. The designs disclosed herein facilitates the direct flow of cooling liquid through the rotor lamination, optimizing heat dissipation, and improving overall thermal performance. Additionally, the examples disclosed herein include modifications to both the rotor lamination design and rotor bar design to ensure that electromagnetic performance of the electric machine remains unaffected.

As will become appreciated from the following discussion, a rotor electric steel lamination configuration is provided that improves the thermal performance of a squirrel-cage IM by incorporating a cooling path encapsulated in the rotor core. The rotor cooling method is based on allowing the cooling fluid to flow through the rotor lamination close to the rotor bars. This allows the cooling to be enclosed inside the rotor core, which maximizes the cooling efficiency. The incorporation of cooling channels within the rotor laminations could risk constraining the magnetic flux path within the rotor lamination, leading to electric steel saturation, higher loses and performance limitations. However, the design provided herein addresses this issue by optimizing and modifying the shape of the rotor lamination and the rotor bars. The adjustments ensure that the modified area exceeds or matches the area occupied by the cooling channels. This allows for more flexibility in the design of the cooling channels without necessitating concern for their impact on the electromagnetic performance.

The proposed flow of cooling in the rotor lamination can include two options. In a first option, the end rings are utilized. One end ring is used as an inlet for the coolant, which will be responsible for spreading the coolant to every cooling channel. A second end ring plate will be used as a coolant outlet. The coolant that will flow out of the end ring will be splashed to cool the stator core and stator winding providing improved thermal management. For this option, holes need to be included in the end ring and aligned with the rotor coolant channels to control the flow into the rotor core and out from the rotor core.

In a second option, the rotor endplates are utilized. A first endplate will be used as an inlet for the coolant, while a second endplate is used as the coolant outlet. In this second example, a special lamination is positioned at both ends of the rotor core (such as 2-3 laminations per side). The main function of these laminations is to direct the flow of inlet cooling fluid from the endplate into the rotor core and guide the outlet cooling fluid from the rotor core to the endplate. The flow to the end plate can be controlled from the shaft to the endplate and from the endplate to the shaft to control the outlet flow. Holes need to be included in the end plate and aligned with the rotor coolant flow guide to control the flow into the rotor core and out from the rotor core.

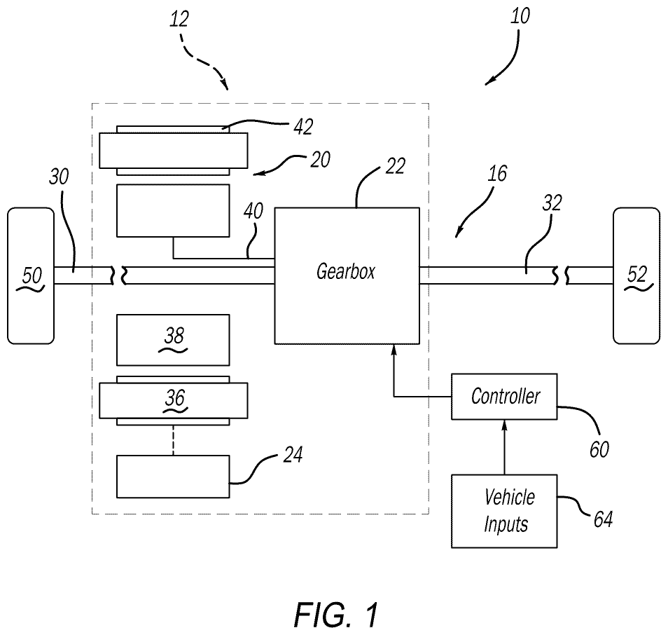

With initial reference to FIG. 1, a vehicle 10 is partially shown in accordance with the principles of the present disclosure. In the example embodiment, vehicle 10 includes an electric drive module (EDM) 12 configured to generate and transfer drive torque to a driveline 16 for vehicle propulsion. The EDM 12 generally includes one or more electric drive units or machines 20 (e.g., electric traction machines), a gearbox assembly 22, and power electronics including a power inverter module (PIM) 24. The electric machine 20 is selectively connectable via the PIM 24 to a high voltage battery system (not shown) for powering the electric machine 20. The gearbox assembly 22 is configured to transfer the generated drive torque to the driveline 16, including a first or left axle shaft 30 configured to drive a left wheel 50 and a second or right axle shaft 32 configured to drive a right wheel 52.

In the example shown, the EDM 12 is configured for use on a rear axle of a two-wheel drive vehicle. It is appreciated however that the EDM 12 can be alternatively configured for use on a front axle of a two-wheel drive vehicle. In other examples an EDM 12 can be provided on both of the front and rear axles for a four-wheel drive or all-wheel drive driveline vehicle. In the example embodiment, the electric machine 20 generally includes a stator assembly 36, a rotor assembly 38 and a rotor output shaft 40. It will be appreciated that while the exemplary vehicle 10 is configured as an electric vehicle, the electric machine 20 can be suitable for use with other vehicle configurations that have electric machines 20 including those that also employ other supplemental drive sources (e.g., hybrid vehicles that also include internal combustion engines, etc.).

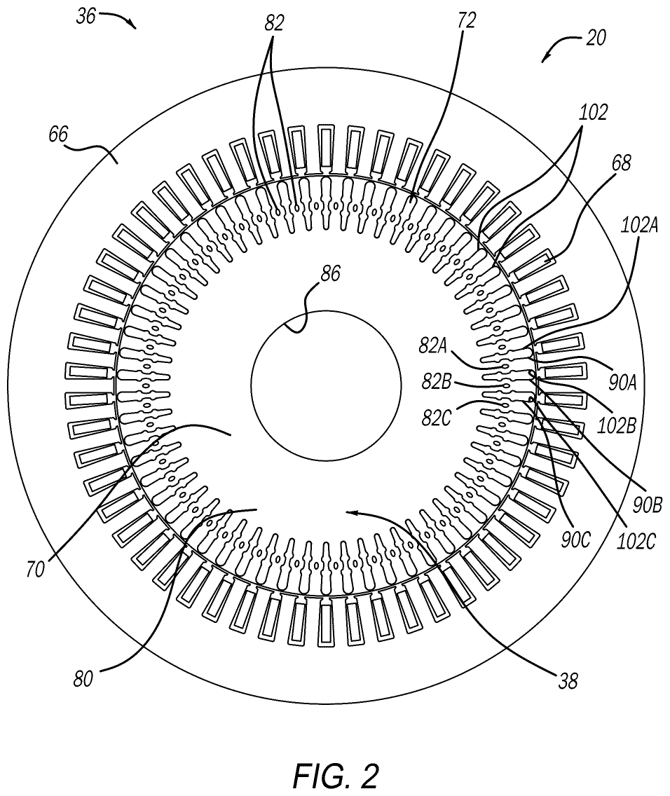

With additional reference now to FIGS. 2-4, additional features of the electric machine 20 constructed in accordance to one example of the present disclosure will be described. The stator assembly 36 generally includes a stator core 66 having stator windings 68 thereon. The rotor assembly 38 generally comprises a rotor core 70, and a first bar assembly 72. The rotor core 70 generally comprises a plurality of laminations 78 that form a core body 80 that defines coolant channels collectively identified at 82 and individually identified at 82A, 82B, 82C, etc. The coolant channels 82 are generally oval shaped. The core body 80 defines a central passage 86 for receiving the rotor shaft 40 (FIG. 1). A plurality of bar passages, are collectively identified at reference numeral 90 and individually identified at 90A, 90B, 90C, etc., are defined circumferentially through the core body 80.

The first bar assembly 72 includes a plurality of bars, collectively identified at reference numeral 102, that are circumferentially arranged. The bars 102 are individually identified at reference numerals 102A, 102B, 102C, etc. While 58 bars are shown, it will be appreciated that other quantities may be implemented within the scope of the present disclosure. As will be described in greater detail herein, the coolant channels 82 are arranged between adjacent bars 102 around the rotor core 70.

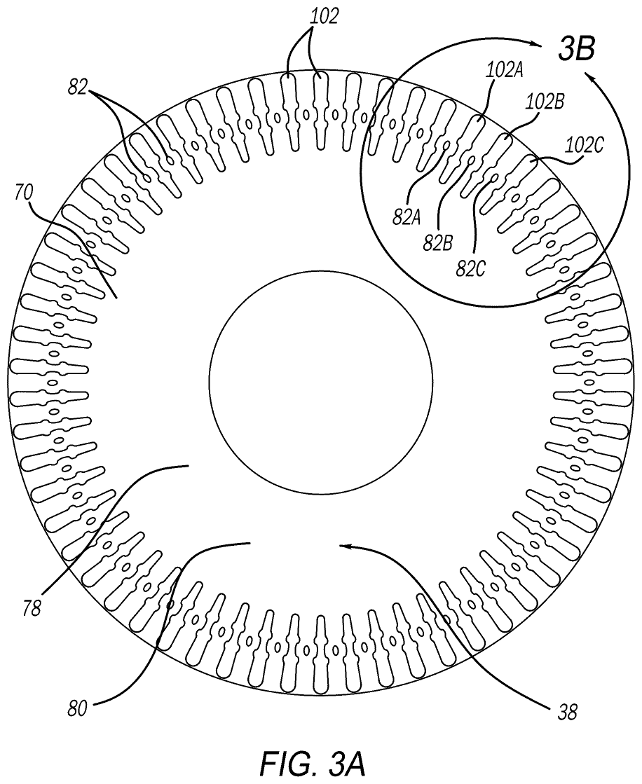

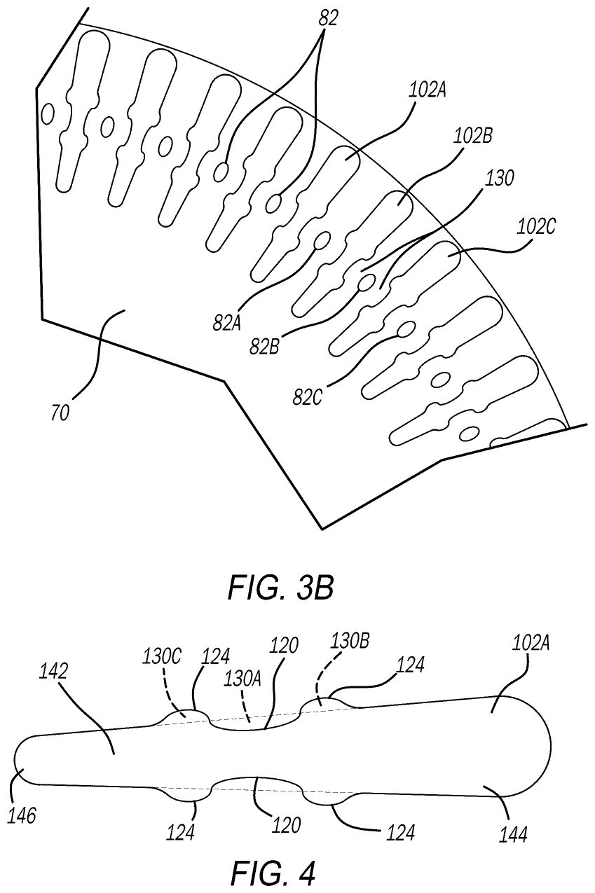

With particular reference to FIGS. 3B and 4, a first bar 102A will be described with the appreciation that all of the bars 102 are similarly formed. The profile of the bars 102 each include an inwardly extending concave portion 120 between a pair of outwardly extending finger portions 124. The coolant channels 82 are generally arranged intermediate oppositely facing concave portions 120. In advantages, a rotor core separating portion 130 defining an amount of rotor core 70 present between the coolant channels 82 and the oppositely facing concave portions 120 maintains suitable magnetic flux within the rotor while improving cooling. The first bar 102A includes an inboard portion 142 and an outboard body portion 144. The inboard body portion 142 terminates at an opposite end of the outboard body portion 144 at a distal end 146. To prevent any impact on the electromagnetic performance of the squirrel-cage IM with the added coolant channels 82, the modified rotor lamination and rotor bar shape area is equal or larger than the area of the coolant channels such that:

$$2 x A \geq {A}_{c o o lant channel}$$

Furthermore, areas 130B, 130C are added to the rotor bar to maintain the same overall rotor bar area. The areas 130B and 130C are designed such that:

$$130 A = 130 B + 130 C$$

The disclosure is also valid if there are multiple coolant channels in the tooth such that:

$$: 2 xA \geq {\sum }_{1}^{i} Ai coolant$$

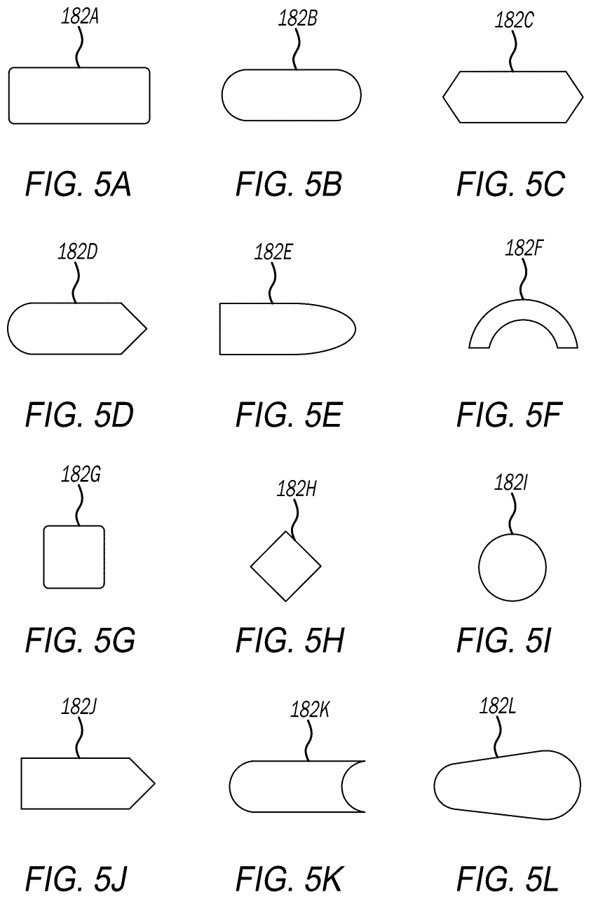

FIGS. 5A-5L are sectional view of various exemplary alternative coolant channels 182A-182L according to additional examples of the present disclosure. It will be appreciated that coolant channels having other geometries and configurations may be incorporated. The shape and number of the cooling channels can vary based on the required cooling flow rate, heat generated, and the pressure drop.

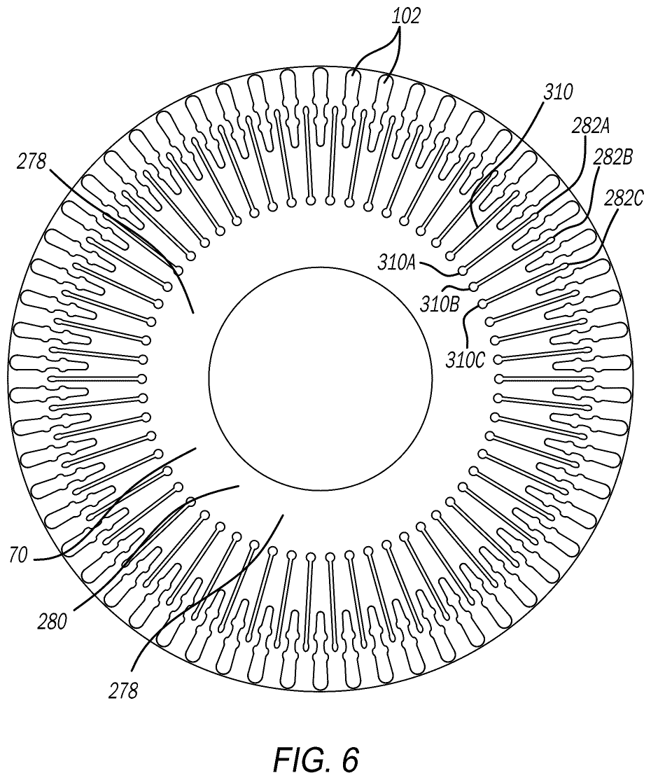

FIG. 6 is a sectional view of a rotor core lamination 278 and associated bars or rods 102 of the squirrel-cage induction rotor assembly and incorporating cooling flow guides, collectively identified at reference numeral 310 in accordance with a second example of the present application. The rotor lamination 278 configured for use at opposite ends of the rotor core 70.

The rotor lamination 278 generally comprises a lamination body 280 that defines coolant channels collectively identified at 282 and individually identified at 282A, 282B, 282C, etc. The coolant channels 282A, 282B, 282C align with the coolant channels 82A, 82B, 82C on the laminations 78. The cooling flow guides 310, individually identified at 310A, 310B, 310C connect with the coolant channels 282A, 282B, 282C. As identified above, The main function of the laminations 278 is to direct the flow of inlet cooling fluid from the endplate into the rotor core 70 and guide the outlet cooling fluid from the rotor core 70 to the endplate. The flow to the end plate can be controlled from the shaft to the endplate and from the endplate to the shaft to control the outlet flow. Holes need to be included in the end plate and aligned with the rotor coolant flow guide to control the flow into the rotor core and out from the rotor core.

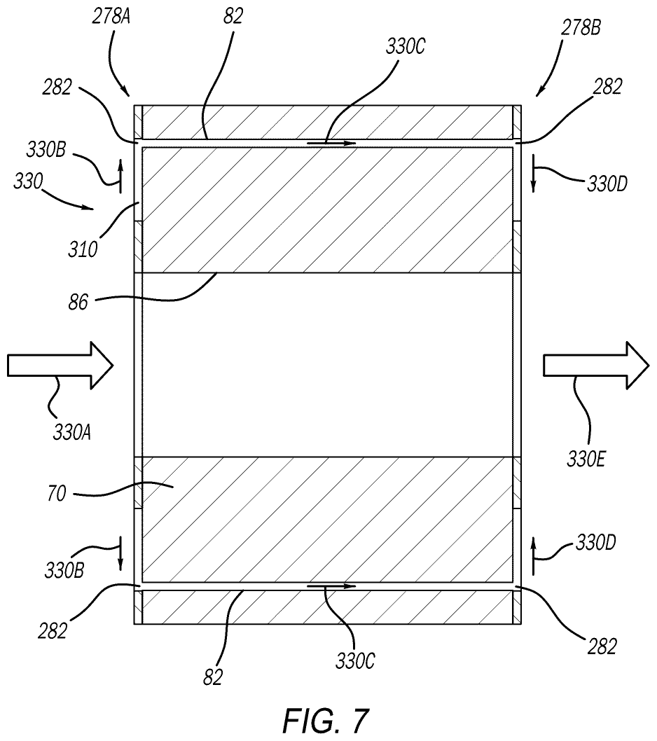

FIG. 7 is a sectional view of a rotor core 70 showing coolant flow, collectively identified at 330, according to various examples of the present disclosure. Coolant 330A enters the rotor core 70 at central passage 86. The end laminations 278A and 278B direct the coolant 330B along the cooling flow guides 310 and into the end lamination channels 282. From there, the coolant 330C flows through the coolant channels 82. The coolant 330D exits at the end lamination channels 282 and flows along the cooling flow guides 310 and exits the rotor at 330E.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric machine for powering an electric vehicle, the electric machine comprising:
a rotor assembly configured to rotate relative to a stator to drive a rotor shaft and at least one drive wheel of the electric vehicle, the rotor assembly comprising:
a rotor core having a core body that includes a plurality of first laminations that define a plurality of circumferentially arranged bar passages and a plurality of coolant channels comprising a coolant channel arranged between adjacent bar passages; and
a bar assembly having a plurality of bars received at the bar passages in the rotor core, each of the bars having an inboard body portion, an outboard body portion, and inwardly extending concave portions defined on opposite sides of the bars;
wherein a coolant channel of the plurality of coolant channels is arranged intermediate adjacent bars of the plurality of bars and aligned generally between respective opposing inwardly extending concave portions.

2. The electric machine of claim 1, wherein the core body includes a rotor core separating portion having an area that is at least a corresponding area of the coolant channel.

3. The electric machine of claim 1, wherein the bars further include outwardly extending finger portions on opposed ends of the respective concave portions.

4. The electric machine of claim 1, wherein the rotor core further comprises a first end lamination positioned at a first end of the rotor core and a second end lamination positioned at a second end of the rotor core.

5. The electric machine of claim 4, wherein the first and second end laminations include a plurality of cooling flow guides formed therein, the plurality of cooling flow guides fluidly connected to the coolant channels.

6. The electric machine of claim 5, wherein the first and second end laminations control flow of coolant into and out of the rotor core.

7. The electric machine of claim 1, wherein the coolant channels are oval shaped.

8. The electric machine of claim 3, wherein an area of an inwardly extending concave portion is equal to a sum of an area of outwardly extending finger portions on opposed ends of the inwardly extending concave portion.

9. The electric machine of claim 1, further comprising:
a stator assembly including a stator core having stator windings thereon.
